(19) United States
(12) Patent Application Publication
(10) Pub. No.: US 2026/0188077 A1
(43) Pub. Date: Jul. 2, 2026

(54) SYSTEM, METHOD, AND NON-TRANSITORY COMPUTER-READABLE STORAGE MEDIUM STORING PROGRAM FOR PROVIDING GAME

(71) Applicant: DeNA Co., Ltd., Tokyo (JP)

(72) Inventor: Tetsuya Iguchi, Tokyo (JP)

(73) Assignee: DeNA Co., Ltd., Tokyo (JP)

(21) Appl. No.: 19/548,965

(22) Filed: Feb. 25, 2026

Related U.S. Application Data
(63) Continuation of application No. PCT/JP2024/022737, filed on Jun. 24, 2024.

(30) Foreign Application Priority Data
Aug. 25, 2023 (JP) 2023-137598

(51) Int. Cl. G07F 17/32

(52) U.S. Cl. CPC G07F 17/3262; G07F 17/3286

(57) ABSTRACT

A game providing server according to an embodiment of the present invention allows players to enhance their interest in a game. The server provides a game to a user who operates a player terminal communicatively connected through a communication network. The server decreases the remaining draw count, performs a first draw to determine winning identification information from among multiple pieces of identification information, changes an area corresponding to the winning identification information to a winning area, in response to the arrangement of multiple winning areas forming a predetermined pattern, gives a first reward, in response to the winning identification information being determined, performs a second draw to determine whether to increase the remaining draw count, and, if the result of the second draw is a win, increases the remaining draw count. Thus, the player is allowed to enjoy acquiring the reward based on the arrangement of the winning areas while considering the increase or decrease in the remaining draw count.

### CROSS-REFERENCE TO RELATED APPLICATIONS

The present application is a continuation of the international application No. PCT/JP2024/022737, filed on Jun. 24, 2024, the content of which is incorporated herein in its entirety by reference.

### TECHNICAL FIELD

The present invention relates to a system, method, and program for providing a game.

### BACKGROUND

Technologies for providing a bingo game using a computer have been proposed. For example, Patent Literature 1 discloses an apparatus that receives a game participation request transmitted from a terminal device and provides, to the terminal device, a game in which a win is obtained when numbers sequentially distributed from the apparatus to the terminal device form a predetermined arrangement pattern.

[Patent Literature 1] Japanese Unexamined Patent Application Publication No. 2001-340642

### SUMMARY

While the conventional apparatus described above allows the user of the terminal device to easily enjoy the typical bingo game, the game may progress monotonously due to lack of novelty in design. Therefore, it is desirable to allow users to enhance their interest in games, such as a bingo game.

One object of embodiments of the present invention is to allow users to enhance their interest in games. Other objects of the embodiments of the present invention will become apparent upon reference to the entire specification.

A system according to an embodiment of the present invention is a system for providing a game. The system includes one or more computer processors. The one or more computer processors perform operations comprising presenting, to a player, a predetermined screen that is used to play the game and displays a game field in which multiple areas each corresponding to one of multiple pieces of different identification information are arranged, performing a first draw to determine winning identification information from among the pieces of identification information and decreasing a remaining draw count associated with the player, in response to the winning identification information being determined through the first draw, changing an area corresponding to the winning identification information among the areas to a winning area, in response to the winning identification information being determined through the first draw, performing a second draw to determine whether to increase the remaining draw count and, if a result of the second draw is a win, increasing the remaining draw count, and in response to arrangement of multiple winning areas among the areas forming a predetermined pattern, giving a first reward to the player.

A method according to an embodiment of the present invention is a method for providing a game. The method is performed by one or more computers. The method includes presenting, to a player, a predetermined screen that is used to play the game and displays a game field in which multiple areas each corresponding to one of multiple pieces of different identification information are arranged, performing a first draw to determine winning identification information from among the pieces of identification information and decreasing a remaining draw count associated with the player, in response to the winning identification information being determined through the first draw, changing an area corresponding to the winning identification information among the areas to a winning area, in response to the winning identification information being determined through the first draw, performing a second draw to determine whether to increase the remaining draw count and, if a result of the second draw is a win, increasing the remaining draw count, and in response to arrangement of multiple winning areas among the areas forming a predetermined pattern, giving a first reward to the player.

A non-transitory computer-readable storage medium storing a program according to an embodiment of the present invention is a non-transitory computer-readable storage medium storing a program for providing a game. The program causes one or more computers to perform operations comprising presenting, to a player, a predetermined screen that is used to play the game and displays a game field in which multiple areas each corresponding to one of multiple pieces of different identification information are arranged, performing a first draw to determine winning identification information from among the pieces of identification information and decreasing a remaining draw count associated with the player, in response to the winning identification information being determined through the first draw, changing an area corresponding to the winning identification information among the areas to a winning area, in response to the winning identification information being determined through the first draw, performing a second draw to determine whether to increase the remaining draw count and, if a result of the second draw is a win, increasing the remaining draw count, and in response to arrangement of multiple winning areas among the areas forming a predetermined pattern, giving a first reward to the player.

The various embodiments of the present invention allow users to enhance their interest in games.

### BRIEF DESCRIPTION OF THE DRAWINGS

FIG. 1 a schematic diagram showing the configuration of a network including a game providing server according to an embodiment of the present invention.

FIG. 2 is a diagram illustrating information managed by a player information table.

FIG. 3 is a diagram illustrating information managed by a game progress management table.

FIG. 4 is a diagram illustrating information managed by a game field management table.

FIG. 5 is a diagram illustrating information managed by an object management table.

FIG. 6 is a flowchart illustrating a process performed by the game providing server in response to a bingo game being started.

FIG. 7 is a diagram illustrating a game screen.

FIG. 8 is a diagram illustrating details of the bingo sheet display area of the game screen.

FIG. 9 is a diagram illustrating details of the ball containing object of the game screen.

FIG. 10 is a diagram showing three types of bingo balls.

FIG. 11 is a diagram illustrating a winning number display area in which a winning number is displayed.

FIG. 12 is a diagram illustrating the bingo sheet display area in which a visual effect is being displayed in association with the draw of the winning number.

FIG. 13 is a diagram showing a bingo.

### DETAILED DESCRIPTION

Embodiments of the present invention will now be described with reference to the accompanying drawings. In the drawings, the same or similar components can be given the same reference signs.

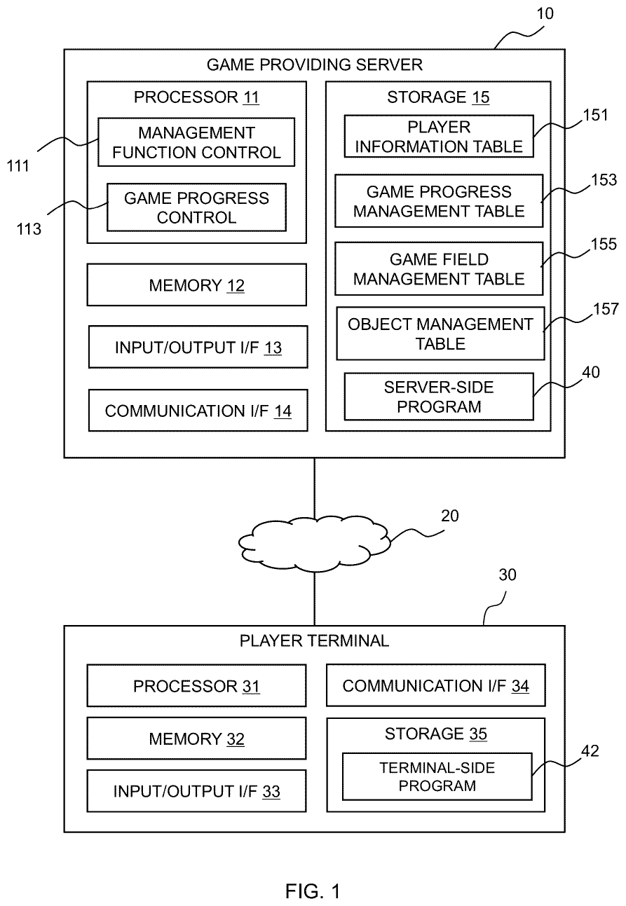

FIG. 1 is a schematic diagram showing the configuration of a network including a game providing server 10 according to an embodiment of the present invention. As shown, the server 10 is communicatively connected to a player terminal 30 through a communication network 20 such as the Internet. Although only one player terminal 30 is shown in FIG. 1, the server 10 can be communicatively connected to multiple player terminals 30. The server 10 provides a game to a user who operates the player terminal 30. The game providing server 10 is an example of an apparatus that implements all or part of the system of the present invention.

First, the hardware configuration of the game providing server 10 will be described. The game providing server 10 consists of a general-purpose computer. As shown in FIG. 1, it includes a computer processor 11, main memory 12, an input/output I/F 13, a communication I/F 14, and storage 15. These components are electrically connected to each other through a bus or the like (not shown).

The computer processor 11 consists of a CPU, GPU, or the like. It loads any program stored in the storage 15 or the like into the main memory 12 and executes various instructions included in the program. The main memory 12 consists of, for example, DRAM or the like.

The input/output I/F 13 includes various input/output devices for exchanging information with an operator or the like. For example, the input/output I/F 33 includes an information input device such as a keyboard or a pointing device (e.g., a mouse, touchscreen, etc.), a sound input device such as a microphone, and an image input device such as a camera. The input/output I/F 13 also includes an image output device such as a display and a sound output device such as a speaker.

The communication I/F 14 is implemented as hardware such as a network adapter, any type of communication software, or a combination of these and is configured to perform wired or wireless communication through the communication network 20 or the like.

The storage 15 consists of, for example, a magnetic disk, flash memory, or the like. The storage 15 is storing various programs including an operating system, various types of data, and the like. For example, as shown in FIG. 1, the storage 15 includes a player information table 151 that manages information on the players of games, a game progress management table 153 that manages the progress of the games, a game field management table 155 that manages game fields used in the games, and an object management table 157 that manages information on predetermined objects used when drawing winning identification information. These tables may be partially integrated into a single table or divided into multiple tables.

The storage 15 is also storing, for example, a server-side program 40 according to an embodiment of the present invention. The program 40 is a program for causing the game providing server 10 to function as all or part of the system for providing a game. The server-side program 40 may be configured such that at least part thereof is executed on the player terminal 30 through a terminal-side program 42 (to be described later).

In the present embodiment, the game providing server 10 may consist of multiple computers each having the above hardware configuration. For example, the server 10 may consist of one or more server apparatuses.

The game providing server 10 thus configured function as a web server and application server, that is, performs various processes in response to a request from the terminal-side program 42 installed on the player terminal 30 and sends screen data (e.g., HTML data), control data, and the like corresponding to the results of the processes to the player terminal 30. The player terminal 30 outputs thereon webpages or other screens based on the received data.

Next, the hardware configuration of the player terminal 30 will be described. The player terminal 30 consists of a general-purpose computer. As shown in FIG. 1, it includes a computer processor 31, main memory 32, an input/output I/F 33, a communication I/F 34, and storage 35. These components are electrically connected to each other through a bus or the like (not shown).

The computer processor 31 consists of a CPU, GPU, or the like. It loads any program stored in the storage 35 or the like into the main memory 32 and executes various commands included in the program. The main memory 32 consists of, for example, DRAM or the like.

The input/output I/F 33 includes various input/output devices for exchanging information with an operator or the like. For example, the input/output I/F 33 includes an information input device such as a keyboard or a pointing device (e.g., a mouse, touchscreen, etc.), a sound input device such as a microphone, and an image input device such as a camera. The input/output I/F 33 also includes an image output device such as a display and a sound output device such as a speaker.

The communication I/F 34 is implemented as hardware such as a network adapter, any type of communication software, or a combination of these and is configured to perform wired or wireless communication through the communication network 20 or the like.

The storage 35 consists of, for example, a magnetic disk, flash memory, or the like. The storage 35 is storing various programs including an operating system, various types of data, and the like. The programs stored in the storage 35 can be downloaded and installed from an application market or the like. The storage 35 is also storing the above-mentioned terminal-side program 42. The program 42 consists of a web browser or any other application (e.g., a game application, etc.) and may be configured to execute at least a part of the server-side program 40, as described above.

In the present embodiment, the player terminal 30 may consist of a smartphone, a tablet terminal, a wearable device, a personal computer, a terminal dedicated for a game, or the like.

The user (game player) of the player terminal 30 configured thus can play a game provided by the server 10 by communicating with the server 10 through the terminal-side program 42 installed on the storage 35 or the like.

Next, the functions of the game providing server 10 configured as described above will be described. As shown in FIG. 1, the computer processor 11 of the server 10 is configured to function as a management function control unit 111 and a game progress control unit 113 by executing instructions included in a program (e.g., at least a part of the server-side program 40) loaded into the main memory 12.

The management function control unit 111 is configured to perform various processes related to the control of game management functions. For example, the management function control unit 111 sends screen data, control data, and the like on various screens related to the management functions to the player terminal 30, performs various processes in response to inputs made by the player through the screens outputted on the player terminal 30, and sends the screen data, control data, and the like corresponding to the results of the processes to the player terminal 30. Examples of the management functions controlled by the management function control unit 111 include login processing (user authentication), billing control, player account management, and the like.

The game progress control unit 113 is configured to perform various processes related to the progress control of games. For example, the game progress control unit 113 sends screen data, control data, and the like on various screens for progressing a game to the player terminal 30, performs various processes in response to inputs made by the player through the screens outputted on the player terminal 30, and sends the screen data, control data, and the like corresponding to the results of the processes to the player terminal 30.

In the present embodiment, the game progress control unit 113 is configured to present, to the player, a predetermined screen that is used to play the game and displays a game field in which multiple areas are arranged. For example, the game progress control unit 113 sends screen data, control data, and the like on this screen to the player terminal 30. The areas arranged in the game field are configured to correspond to one of multiple pieces of different identification information. The correspondences between the areas and the pieces of identification information are managed, for example, in the game field management table 155. Examples of the pieces of identification information include, but not limited to, numbers, characters, patterns, and the like.

The game progress control unit 113 is also configured to, in accordance with an instruction made by the player, the lapse of time, or the like, perform a first draw to determine winning identification information from the pieces of identification information and decrease the remaining draw count associated with the player. The first draw is performed, for example, in accordance with the respective winning probabilities of the pieces of identification information. All the pieces of identification information may have the same winning probability, or at least some pieces of identification information may have different winning probabilities. The remaining draw count of the player is managed, for example, in the game progress management table 153. The first draw is repeated each time the player makes an instruction.

The game progress control unit 113 is also configured to, in response to the winning identification information being determined through the first draw, change an area corresponding to the winning identification information among the areas arranged in the game field, to a winning area. The statuses of the areas in the game field (whether each area is a winning area) are managed, for example, in the game field management table 155. Typically, in response to one area being changed to a winning area, the display mode of the area on the predetermined screen is changed.

The game progress control unit 113 is also configured to, in response to the winning identification information being determined, perform a second draw to determine whether the remaining draw count will be increased and to, when the result of the second draw is a win, increase the remaining draw count. The second draw may be performed each time winning identification information is determined (i.e., the first draw is performed), or it may be performed when a predetermined condition is satisfied after winning identification information is determined.

The game progress control unit 113 is also configured to, in response to the arrangement of multiple winning areas among the multiple areas forming a predetermined pattern, give a first reward to the player. For example, assuming that the multiple areas in the game field are arranged in a grid, the first reward is given in response to winning areas being aligned vertically, horizontally, or diagonally. The first reward may be of various types. For example, the first reward may consist of a reward (such as items, coins, or points) used in other games.

As described above, the game providing server 10 according to the present embodiment decreases the remaining draw count, performs the first draw to determine winning identification information from the multiple pieces of identification information, changes the area corresponding to the winning identification information to the winning area, in response to the arrangement of the multiple winning areas forming the predetermined pattern, gives the first reward, in response to the winning identification information being determined, performs the second draw to determine whether the remaining draw count will be increased, and, when the result of the second draw is a win, increases the remaining draw count. Thus, the player is allowed to enjoy acquiring the reward based on the arrangement of the winning areas while considering the increase or decrease in the remaining draw count. In this way, the server 10 allows the player to enhance their interest in the game.

In the present embodiment, the first draw to determine the winning identification information may include determining the winning identification information from among pieces of yet-to-win identification information among the multiple pieces of identification information. The winning statuses of the pieces of identification information (whether each identification information is a win) are managed, for example, in the game progress management table 153, game field management table 155, or object management table 157.

In the present embodiment, the multiple areas in the game field may be configured to include areas corresponding to the multiple pieces of identification information. For example, a predetermined number of (two or more) areas may be configured to correspond to the same predetermined number of pieces of identification information. According to this configuration, the area corresponding to the winning identification information determined through the first draw is included in the multiple areas, which allows the game to progress in a good tempo.

In the present embodiment, the winning probability of the second draw to determine whether the remaining draw count will be increased may be configured to be higher as the remaining draw count at that point in time is smaller. This configuration encourages the player whose remaining draw count has been decreased to continue to play the game.

The winning probability of the second draw may be configured to be changed on the basis of the progress status of the game. Examples of the progress status of the game includes, but not limited to, the number of execution of the first draw to determine winning identification information, the status of change of the multiple areas to winning areas (e.g., the status of arrangement of multiple winning areas, etc.), and the status of giving of the first reward. According to this configuration, the possibility of restoration of the remaining draw count can be changed on the basis of the progress status of the game.

The game progress control unit 113 may also be configured to, in response to the player consuming a predetermined value (e.g., making a payment), increase the remaining draw count. Examples of the predetermined value include a real value (e.g., currency) and a virtual value (e.g., an item). This configuration allows the player to continue the game by consuming the predetermined value.

In the present embodiment, in response to the area corresponding to the winning identification information being changed to a winning area, a second reward may be given to the player. The second reward may be of the same type as or of a different type from that of the first reward given in response to the arrangement of the multiple winning areas forming the predetermined pattern. This configuration allows the player to enjoy acquiring the reward in response to the area corresponding to the winning identification information being changed to the winning area.

In this case, the multiple pieces of identification information may each have a parameter, and the second reward based on the value of the parameter of the winning identification information may be given. For example, the value (such as the quantity) for the player of the second reward may be changed on the basis of the value of the parameter. The parameter may be the identification information itself. This configuration allows the player to enjoy acquiring the second reward based on the value of the parameter of the winning identification information.

The multiple areas in the game field may each have a parameter, and the second reward based on the value of the parameter of the area corresponding to the winning identification information may be given. For example, the value (such as the quantity) for the player of the second reward may be changed on the basis of the value of the parameter. This configuration allows the player to enjoy acquiring the second reward based on the value of the parameter of the area corresponding to the winning identification information.

In the present embodiment, the predetermined screen for playing the game may be configured to display multiple predetermined objects corresponding to the pieces of yet-to-win identification information among the multiple pieces of identification information such that the corresponding pieces of yet-to-win identification information cannot be recognized. In this case, the game progress control unit 113 may be configured to, in response to one of the multiple predetermined objects being specified, perform the first draw. The predetermined object may be specified in response to the player selecting the predetermined object, or automatically by the game progress control unit 113. This configuration allows the objects corresponding to the pieces of yet-to-win identification information to be displayed when performing the first draw.

In this case, the multiple predetermined objects may each have a parameter, and the second draw to determine whether the remaining draw count will be increased may have a winning probability based on the value of the parameter of the predetermined object specified when performing the first draw. The parameters of the predetermined objects are managed, for example, in the object management table 157. This configuration allows the player to enjoy performing the second draw based on the value of the parameter of the predetermined object.

The second reward based on the parameter value of the predetermined object specified when performing the first draw may be given. For example, the value (such as the quantity) for the player of the second reward may be changed on the basis of the value of the parameter. This configuration allows the player to enjoy acquiring the second reward based on the parameter value of the predetermined object.

The game progress control unit 113 may be configured to, in response to a predetermined condition being satisfied, end the play of the game using the game field. Examples of the predetermined condition include, but not limited to, a condition that is satisfied when the remaining draw count becomes zero or when a predetermined time elapses since the start of the game. This configuration encourages the player to acquire the first reward before the play of the game is ended, allowing the player to enhance their interest in the game.

In the present embodiment, the game field may have multiple levels, and, after the play of the game is ended, the level of the game field for the next game may be changed (raised or lowered) in response to a predetermined condition being satisfied. Examples of the predetermined condition include various conditions, such as a condition related to the progress status of the game (e.g., the status of acquisition of the first reward and/or the second reward, etc.). For example, as the level of the game field is raised, the difficulty in acquiring the first reward (in other words, the difficulty with which the arrangement of multiple winning areas forms the predetermined pattern) is increased and the value of the first reward is increased. This configuration allows the player to enjoy a change in the level of the game field.

Next, a specific example as one aspect of the game providing server 10 according to the present embodiment having these functions will be described. In this example, the server 10 provides a solo-play bingo game that is played by a single player.

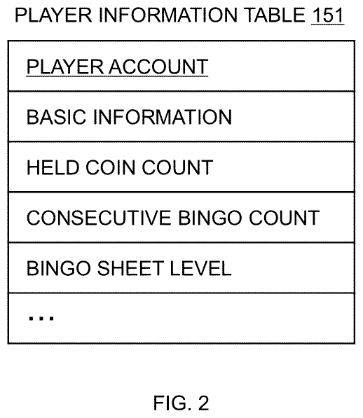

First, information managed by each table in this example will be described. FIG. 2 illustrates information managed by a player information table 151 in this example. The player information table 151 in this example manages information on the players of a game. Specifically, as shown, it manages information such as “basic information” that includes the account name, birth date, and the like of a specific player of a game, a “held coin count” that is the number of coins (the first and second rewards) acquired by playing the bingo game, a “consecutive bingo count” that is the number of consecutive plays that have achieved bingos, and a “bingo sheet level” that is the level of a bingo sheet (game field) used to play the bingo game such that these pieces of information are associated with a “player account” that identifies the specific player. The bingo sheet level is set to “1” as its initial value.

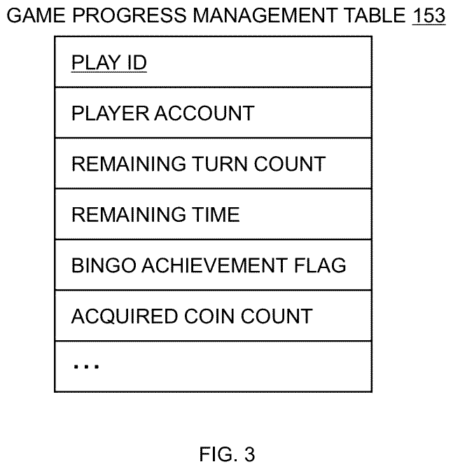

FIG. 3 illustrates information managed by the game progress management table 153 in this example. The game progress management table 153 in this example manages information related to the progress of a specific game. More specifically, as shown, it manages information such as a “player account” that identifies a player of a game, a “remaining turn count” (remaining draw count) that represents the number of remaining draws (first draws) to determine a winning number in the bingo game, a “remaining time”, a “bingo achievement flag” that indicates that one or more bingos have been achieved, and an “acquired coin count” such that these pieces of information are associated with a “play ID” that identifies a specific play of the game.

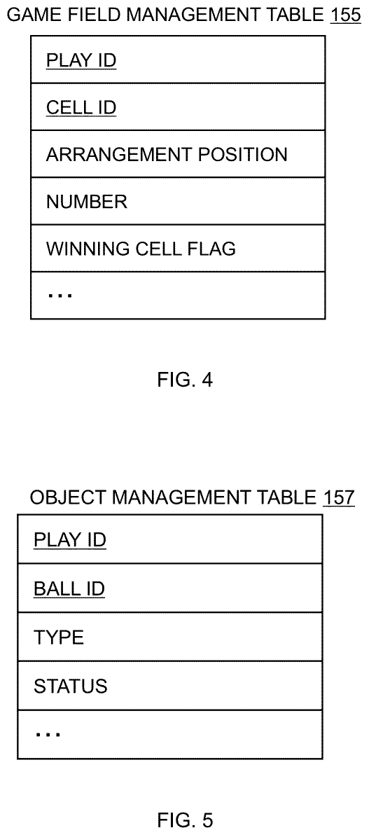

FIG. 4 illustrates information managed by the game field management table 155 in this example. The game field management table 155 in this example manages information on a bingo sheet used to play a bingo game. Specifically, as shown, it manages information such as an “arrangement position” that represents the position of a specific cell (area) arranged on a bingo sheet, a “number” that represents a number (identification information) corresponding to (assigned to) the cell, and a “winning cell flag” that indicates whether the cell is a winning cell such that these pieces of information are associated with a combination of a “play ID” that identifies a specific play of the bingo game and a “cell ID” that identifies the cell.

In this example, N×N cells are arranged vertically and horizontally in a grid in the bingo sheet. A combination of a vertical position (row) and a horizontal position (column) is set in the arrangement position field of the game field management table 155.

FIG. 5 illustrates information managed by the object management table 157 in this example. The object management table 157 in this example manages information on bingo balls (predetermined objects) used to play a bingo game. Specifically, as shown, it manages information such as a “type” that represents the type of a specific bingo ball in a specific play of a bingo game and a “status” that represents the status of the specific bingo ball such that these pieces of information are associated with a combination of a “play ID” that identifies the specific play and a “ball ID” that identifies the specific bingo ball.

The foregoing is the description of the information managed by the tables in this example. Next, processes performed by the server 10, screens outputted on the player terminal 30, and the like in this example will be described.

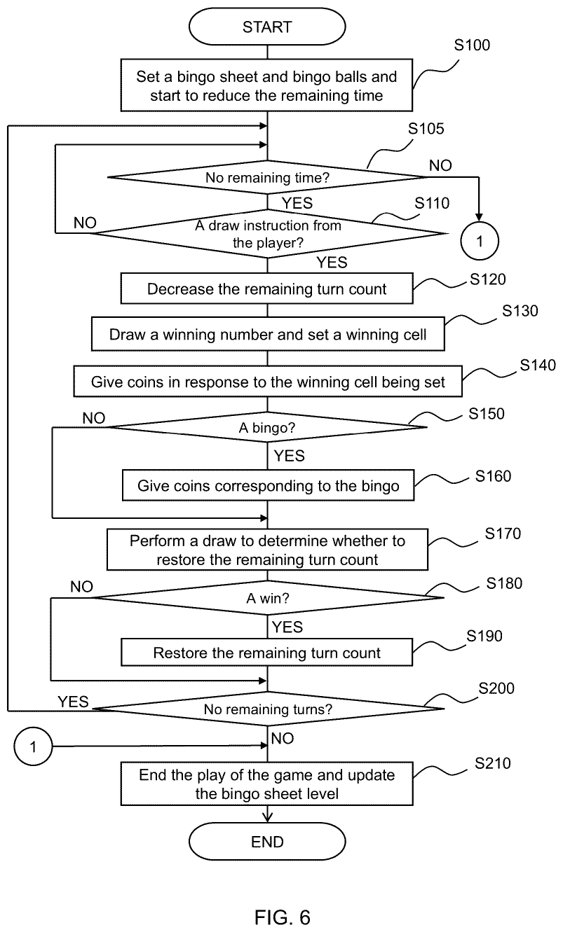

FIG. 6 is a flowchart illustrating a process performed by the game providing server 10 in response to start of a bingo game in this example. As shown, the server 10 first sets a bingo sheet and bingo balls and starts to reduce the remaining time (step S100).

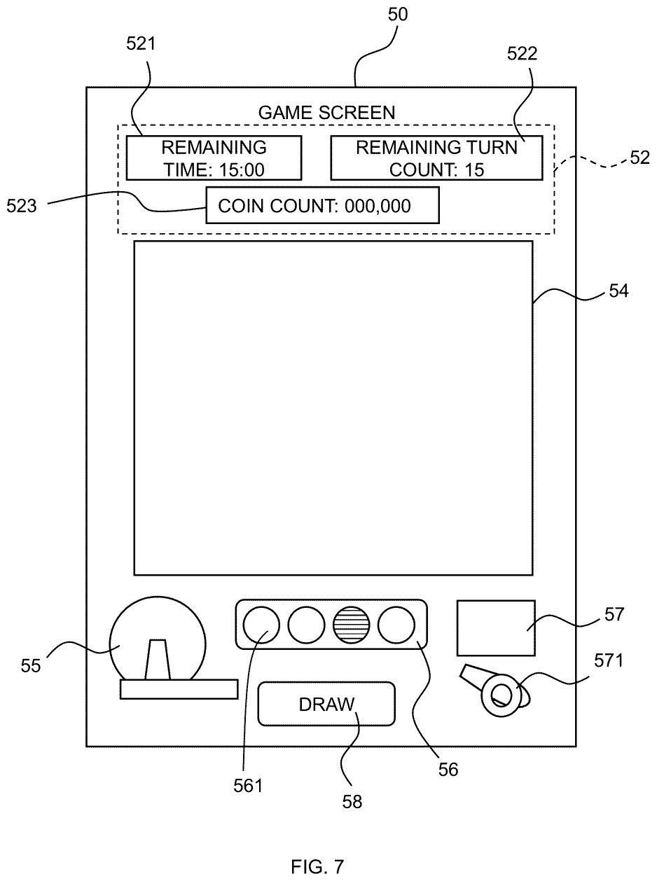

FIG. 7 illustrates a game screen 50 (predetermined screen) outputted on the player terminal 30 in response to the start of the bingo game. As shown, the screen 50 includes a basic information display area 52 for displaying basic information on the game, a bingo sheet display area 54 for displaying the bingo sheet, a ball containing object 55 for containing bingo balls used to draw a winning number, a standby ball display area 56 for displaying four bingo balls used for the next and subsequent draws, a winning number display area 57 for displaying a winning number, and a draw button 58. Below the winning number display area 57 is a cannon object 571 having the appearance of a cannon.

The basic information display area 52 includes a remaining time display area 521 for displaying the remaining time, a remaining turn count display area 522 for displaying the number of remaining turns, and a coin count display area 523 for displaying the number of coins acquired. These pieces of information are managed in the game progress management table 153.

In this example, the bingo sheet has multiple levels. The initial values of the remaining time and the remaining turn count and the number of cells of the bingo sheet vary among the levels of the bingo sheet. The game screen 50 in FIG. 7 corresponds to a case where the level of the bingo sheet is “1”. In this case, the initial value of the remaining time is 15 minutes, and the initial value of the remaining turn count is 15. The level of the bingo sheet applied to the player is managed in the player information table 151, as described above.

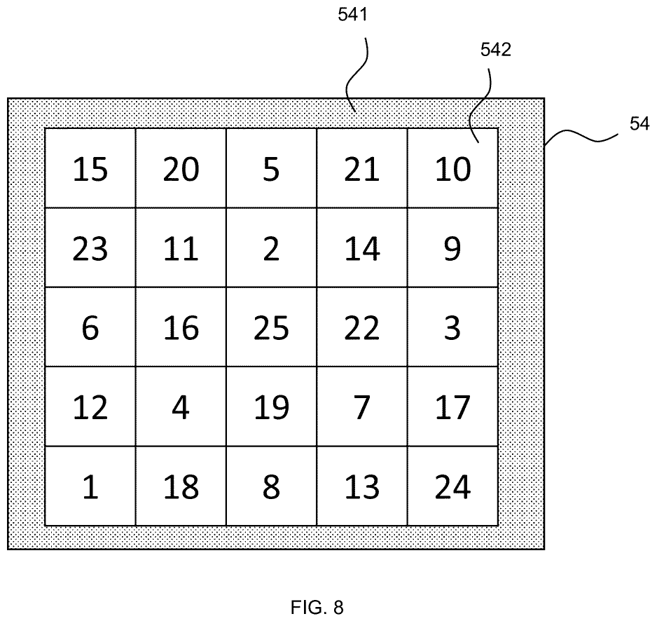

FIG. 8 illustrates details of the bingo sheet display area 54 of the game screen 50. As shown, the area 54 displays a bingo sheet 541, and multiple cells 542 are arranged in a grid in the bingo sheet 541. The level of the bingo sheet 541 in FIG. 8 is “1”, and 5×5(=25) cells are arranged vertically and horizontally.

In step S100, the bingo sheet is set such that numbers of 1 to the maximum value (the number of cells) are randomly assigned to the number of cells corresponding to the level of the bingo sheet. For example, in the bingo sheet 541 in FIG. 8, numbers of 1 to 25 are randomly assigned to the 25 cells 542 and displayed thereon. The numbers assigned to the cells are managed in the game field management table 155, as described above.

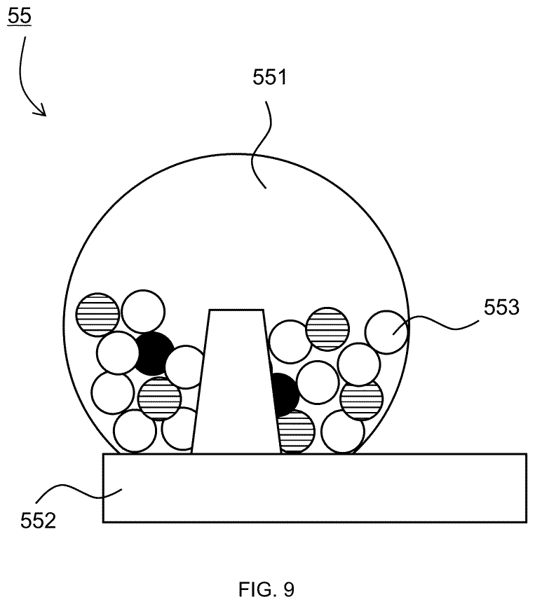

FIG. 9 illustrates details of the ball containing object 55 of the game screen 50. The ball containing object 55 includes a spherical containing portion 551 and a support portion 552 supporting the containing portion 551. Multiple bingo balls 553 are contained in the containing portion 551. In the initial state immediately after the game is started, the remaining 21 bingo balls 553 except for 4 bingo balls placed on the standby ball display area 56 among 25 bingo balls corresponding to the 25 cells are contained in the containing portion 551 of the ball containing object 55. As seen above, in this example, the number of bingo balls is the same as the number of cells of the bingo sheet.

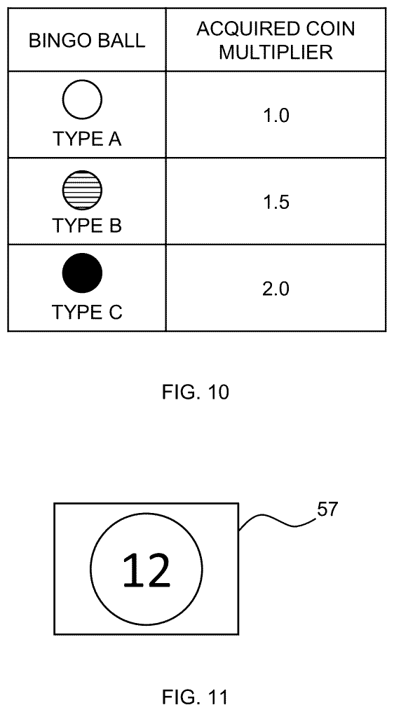

In this example, there are three types of bingo balls, and the values of different parameters (acquired coin multipliers) are set for the three types. FIG. 10 is a diagram showing the three types of bingo balls. As shown, a acquired coin multiplier of “1.0” is set for the type-A bingo balls, a acquired coin multiplier of “1.5” is set for the type-B bingo balls, and a acquired coin multiplier of “2.0” is set for the type-C bingo balls. The three types of bingo balls have different appearances (e.g., colors, patterns, etc.). Details of the acquired coin multipliers will be described later.

While the bingo balls 553 contained in the containing portion 551 of the ball containing object 55 have appearances corresponding to their types, no numbers are displayed thereon (no numbers are assigned to the bingo balls 553).

Referring back to the game screen 50 in FIG. 7, the four bingo balls 561 to be used in the next and subsequent draws are arranged in the left-right direction in the standby ball display area 56. The four bingo balls 561 are arranged such that bingo balls 561 to be used in earlier draws are positioned on the more right side. In other words, the rightmost bingo ball 561 will be used in the next draw.

As with the above-mentioned bingo balls 553, the bingo balls 561 arranged in the standby ball display area 56 have appearances corresponding to their types but no numbers are displayed thereon (no numbers are assigned to the bingo balls 561).

When setting the bingo balls in step S100, the same number of bingo balls as the number of the multiple cells of the bingo sheet are registered in the object management table 157. Moreover, the types and statuses of the multiple bingo balls are set therein. The types of the bingo balls are randomly set by performing draws on the basis of the winning probabilities of the types (type A is highest, type C is lowest). The statuses of the bingo balls include “contained” that indicates that a bingo ball is contained in the containing portion 551 of the ball containing object 55, “first reserve” that indicates that a bingo ball is placed in the rightmost position of the standby ball display area 56, “second reserve” that indicates that a bingo ball is placed in the second most right position of the standby ball display area 56, “third reserve” that indicates that a bingo ball is placed in the third most right position of the standby ball display area 56, “fourth reserve” that indicates that a bingo ball is placed in the fourth most right position (the most left position) of the standby ball display area 56, and “drawn” that indicates that a ball was used to draw a winning number. The bingo balls are set such that a value corresponding to one of “contained,” “first reserve,” “second reserve,” “third reserve,” and “fourth reserve” is set as the status of each bingo ball.

Referring back to the flowchart of FIG. 6, the server 10 sets the bingo sheet and bingo balls and starts to reduce the remaining time. Then, if the time remains (YES in step S105), the server 10 waits for a draw instruction from the player (step S110). A draw instruction from the player is received in response to the player selecting the draw button 58 of the game screen 50.

When the player makes an draw instruction (i.e., selects the draw button 58) (YES in step S110), the server 10 decreases the remaining turn count (step S120). Specifically, the remaining turn count of the corresponding play is updated (decreased by 1) in the game progress management table 153.

The server 10 then draws a winning number and sets a winning cell (step S130). Specifically, it draws one winning number from among yet-to-win numbers among the multiple numbers corresponding to the multiple cells of the bingo sheet and sets (changes) a cell corresponding to the winning number to a winning cell. The yet-to-win numbers are identified by referencing winning cell flags in the game field management table 155. In this example, the winning probabilities of the numbers are the same value. Note that at least some of the multiple numbers may have different winning probabilities. In response to the winning cell being set, the winning cell flag of the corresponding cell is updated in the game field management table 155.

In this example, when the winning number is drawn, a visual effect using bingo balls is displayed on the game screen 50 shown in FIG. 7. Specifically, animation is displayed where the bingo ball 561 placed in the most right position of the standby ball display area 56 is put into the cannon object 571 and one bingo ball 553 (specified through a draw) is supplied from the ball containing object 55 to the most left position of the standby ball display area 56. Then, the winning number is displayed in the winning number display area 57 (see FIG. 11). Then, animation is displayed where the bingo ball 561 is fired from the cannon object 571 and lands on the position of a corresponding cell 542 (to which the winning number is assigned) among the multiple cells 542 of the bingo sheet 541 displayed in the bingo sheet display area 54. In response to such movement of the bingo balls 553, 561, the statuses of these bingo balls are updated in the object management table 157.

Specifically, the status of the bingo ball that has been “first reserve” is changed to “drawn,” the status of the bingo ball that has been “second reserve” is changed to “first reserve,” the status of the bingo ball that has been “third reserve” is changed to “second reserve,” and the status of the bingo ball that has been “fourth reserve” is changed to “third reserve. The status of the bingo ball supplied from the ball containing object 55 to the leftmost position of the standby ball display area 56 is changed from “contained” to “fourth reserve”.

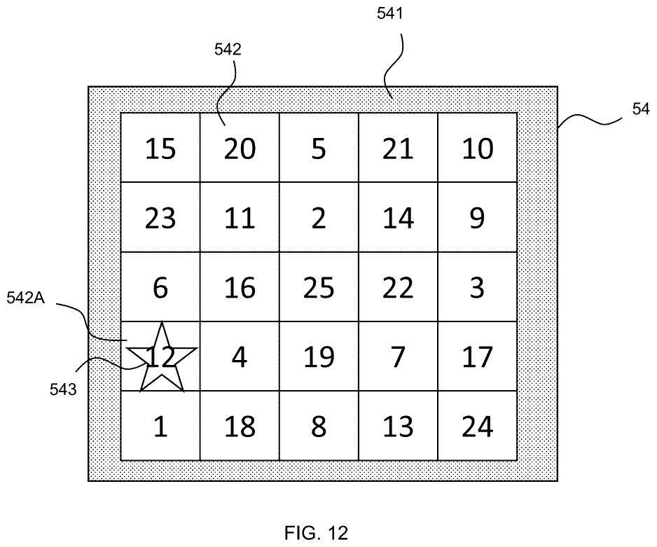

FIG. 12 illustrates the bingo sheet display area 54 in which a visual effect in association with the draw of the winning number is displayed. As shown, in the bingo sheet display area 54 in this state, a cell 542A to which the winning number (“12” in the example in FIG. 12) is assigned among the multiple cells 542 of the bingo sheet 541 is changed to a winning cell, and a star-shaped winning object 543 indicating that the cell 542A is a winning cell is placed on the cell 542A.

Referring back to the flowchart of FIG. 6, after drawing the winning number and setting the winning cell as described above, the server 10 gives coins (second reward) to the player in response to the winning cell being set (step S140). Specifically, the acquired coin count of the corresponding play is updated (increased by a predetermined number) in the game progress management table 153, and the held coin count of the corresponding player is updated (increased by the predetermined number) in the player information table 151. In response to the coins being given, a corresponding visual effect (e.g., animation where objects resembling coins emerge from the cell 542 on which the bingo ball 561 has landed, etc.) may be displayed on the game screen 50.

In this example, the number of coins given in response to the winning cell being set is determined on the basis of the winning number itself and the type of the bingo ball (managed in the object management table 157) used in the draw. Specifically, the base number of coins to be given increases as the value of the winning number increases, and the number of coins obtained by multiplying the base number by a acquired coin multiplier corresponding to the type of the bingo ball used is given to the player.

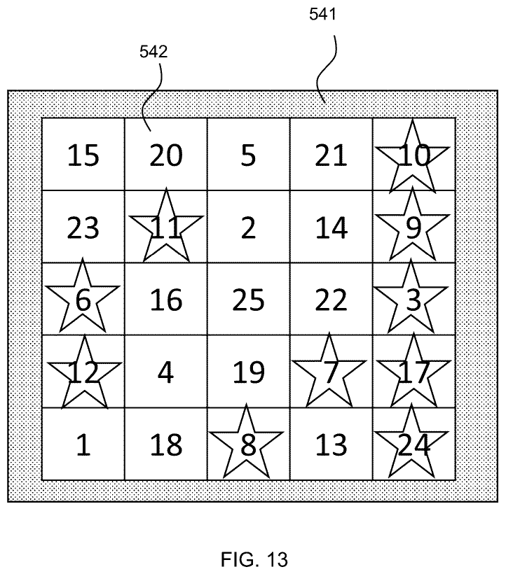

If a bingo is achieved on the bingo sheet 541 as a result of the setting of the winning cell (YES in step S150), the server 10 gives coins (first reward) corresponding to the bingo to the player (step S160). Specifically, the acquired coin count of the corresponding game play is updated (increased by a predetermined number) in the game progress management table 153, and the held coin count of the corresponding player is updated (increased by the predetermined number) in the player information table 151. In response to the coins being given, a corresponding visual effect may be displayed on the game screen 50. The number of coins corresponding to a bingo is previously determined. A bingo means that winning cells are aligned vertically, horizontally, or diagonally. For example, the bingo sheet 541 illustrated in FIG. 13 shows that five cells 542 aligned vertically in the rightmost column are winning cells, meaning achievement of a bingo. In response to the bingo being achieved, the bingo achievement flag of the corresponding play is updated in the game progress management table 153.

Next, the server 10 performs a draw (second draw) to determine whether the remaining turn count will be restored (step S170). Specifically, it performs a draw with a predetermined winning probability to determine whether the remaining turn count will be restored.

The winning probability of the draw to determine whether the remaining turn count will be restored is adjusted by modifying a standard value (e.g., 30%) on the basis of the remaining turn count at that point in time and the type of the bingo ball used to draw the winning number. For example, if the remaining turn count at that point in time are two or fewer, 10 percentage points are added to the standard value of the winning probability. For example, if the type of the bingo ball used is type B, 5 percentage points are added to the winning probability. If the type of the bingo ball is type C, 10 percentage points are added to the winning probability.

If the result of the draw to determine whether the remaining turn count will be restored is a win (YES in step S180), the server 10 restores the remaining turn count. Specifically, the remaining turn count of the corresponding play is updated (increased by 1) in the game progress management table 153.

If there are (one or more) remaining turns (YES in step S200), the server 10 again waits for a draw instruction from the player (step S110). Each time the player makes a draw instruction, the server 10 repeats the series of steps from the decrease in the remaining turn count to the restoration of the remaining turn count when the result of the draw to determine whether the remaining turn count will be restored is a win (steps S120 to S190).

If there is no remaining time (NO in step S105) or if there are no remaining turns (NO in step S200), the server 10 ends the play of the current game and updates the bingo sheet level (step S210). Specifically, if a bingo is being achieved in the play of the current game (the current bingo sheet) (whether a bingo is being achieved is determined by referring to the bingo achievement flag in the game progress management table 153), the consecutive bingo count is updated (increased by 1) in the player information table 151. If the consecutive bingo count reaches a threshold (e.g., 3), the level of the bingo sheet is increased by 1 (level up). In contrast, if no bingo is being achieved in the play of the current game, the consecutive bingo count is cleared to zero and the level of the bingo sheet is decreased by one. When the level of the bingo sheet is increased, the initial values of the remaining time and the remaining turn count are changed (e.g., increased) and the number of cells arranged in the bingo sheet is also changed (e.g., increased). The updated level of the bingo sheet is applied to the play of the next game.

In the above example, the bingo sheet is set such that numbers of 1 to the maximum value (the number of cells) are randomly assigned to the multiple cells corresponding to the level of the bingo sheet. However, the maximum value may be larger than the number of cells. For example, 25 numbers randomly selected from among numbers of 1 to 100 may be assigned to the 25 cells. In this case, a bingo sheet to which larger numbers are assigned is more advantageous for the player (the number of coins given in response to the winning cell being set is larger as the value of the winning number is larger). This makes the bingo sheet hit or miss, allowing the player to enhance their interest in the game. Moreover, the bingo sheet may be set such that one or more cells (e.g., the center cell) are initially set as winning cells.

In the above example, the coins held by the player can be used not only in the bingo game, but also in various types of games other than the bingo game. The coins can also be used to purchase items or the like.

In the above example, the player may be allowed to specify the acquired coin multiplier when making an instruction to draw a winning number. For example, the player may specify the acquired coin multiplier by consuming a predetermined number of coins. In this case, the number of coins given in response to the winning cell being set is determined by using the acquired coin multiplier corresponding to the type of the bingo ball, as well as the acquired coin multiplier specified by the player.

While, in the above example, the number of bingo balls (the number of numbers to be drawn) is set to the same number as the number of cells of the bingo sheet, the number of bingo balls may be set to a number greater than the number of cells. In this case, a cell corresponding to the determined winning number may not be present in the bingo sheet. In this case, giving of the coins in response to the winning cell being set is not performed.

In the above example, the winning probability of the draw to determine whether the remaining turn count will be restored is adjusted on the basis of the remaining turn count at that point in time and the type of the bingo ball. However, the winning probability may be adjusted on the basis of the progress status of the bingo game (the number of execution of the draw to determine a winning number, the arrangement status of winning cells, the acquisition status of coins, etc.) in place of or in addition to the remaining turn count at that point in time and the type of the bingo ball.

In the above example, immediately after the remaining turn count becomes zero or at any timing, the remaining turn count may be increased in response to the player consuming a predetermined value (e.g., real currency, coins, other items, etc.). The remaining turn count may be increased with the lapse of time (e.g., may be restored by one each time one minute elapses). Thus, even when the remaining turn count becomes zero, the player can restore the remaining turn count and continue to play on the bingo sheet at that point in time by consuming a predetermined value, or with the lapse of time, as long as there is remaining time. For example, the player who aims to achieve multiple bingos (and thus to acquire more coins) has motivation to restore the remaining turn count as described above.

While, in the above example, the same type of reward (coins) is given to the player both in response to the winning cell being set and in response to the bingo being achieved, different types of rewards may be given. No reward has to be given in response to the winning cell being set.

In the above example, the number of coins given in response to the winning cell being set may be based on a parameter associated with the winning cell (e.g., the type of the cell). For example, when the center cell among the multiple cells becomes a winning cell, a larger number of coins may be given. Moreover, a special effect (e.g., an effect where another cell is additionally changed to a winning cell, etc.) may be made on the basis of the parameter associated with the winning cell.

The game providing server 10 according to the present embodiment described above decreases the remaining draw count (e.g., the remaining turn count), performs the first draw to determine the winning identification information from among the multiple pieces of identification information (e.g., numbers), changes the area (e.g., cell) corresponding to the winning identification information to the winning area, in response to the arrangement of the multiple winning areas forming the predetermined pattern (e.g., an aligned arrangement pattern, etc.), gives the first reward (e.g., coins), in response to the winning identification information being determined, performs the second draw to determine whether the remaining draw count will be increased, and, if the result of the second draw is a win, increases the remaining draw count. Thus, the player is allowed to enjoy acquiring the reward based on the arrangement of the winning areas while considering the increase or decrease in the remaining draw count. In this way, the server 10 allows the player to enhance their interest in the game.

In another embodiment of the present invention, some or all of the functions of the game providing server 10 according to the above embodiment may be performed by collaboration of the game providing server 10 and player terminal 30, or by the player terminal 30. In other words, the system of the present invention may consist of the game providing server 10, or the game providing server 10 and the player terminal 3, or the player terminal 30.

The processes and procedures described in the present specification may be performed by software, hardware, or any combination thereof other than those described explicitly. For example, the processes and procedures described in the present specification may be performed by implementing logic corresponding to the processes and procedures in a medium such as an integrated circuit, volatile memory, non-volatile memory, or magnetic disk. The processes and procedures described in the present specification may also be implemented as a computer program corresponding to those and performed by various types of computers.

Even when it is stated that the processes and procedures described in the present specification are performed by a single apparatus, software, component, or module, those processes or procedures may be performed by multiple apparatuses, multiple types of software, multiple components, and/or multiple modules. The software and hardware components described in the present specification may be implemented by integrating them into less components or by decomposing them into more components.

When the components of the invention are described in a singular or a plural form in the present specification or even when the components are described without specifying a singular form or plural form, the components may be singular or plural unless the number of each component should be interpreted otherwise in the context.

What is claimed is:

1. A system for providing a game, the system comprising one or more computer processors,
wherein the one or more computer processors perform operations comprising:
presenting, to a player, a predetermined screen that is used to play the game and displays a game field in which a plurality of areas each corresponding to one of a plurality of pieces of different identification information are arranged;
performing a first draw to determine winning identification information from among the pieces of identification information and decreasing a remaining draw count associated with the player;
in response to the winning identification information being determined through the first draw, changing an area corresponding to the winning identification information among the areas to a winning area;
in response to the winning identification information being determined through the first draw, performing a second draw to determine whether to increase the remaining draw count and, if a result of the second draw is a win, increasing the remaining draw count; and
in response to arrangement of a plurality of winning areas among the areas forming a predetermined pattern, giving a first reward to the player.

2. The system of claim 1, wherein the first draw comprises determining the winning identification information from among pieces of yet-to-win identification information among the pieces of identification information.

3. The system of claim 1, wherein the areas comprise areas corresponding to the pieces of identification information.

4. The system of claim 1, wherein a winning probability of the second draw is higher as the remaining draw count is smaller.

5. The system of claim 1, wherein a winning probability of the second draw is changed on the basis of a progress status of the game.

6. The system of claim 5, wherein the progress status of the game comprises at least one of the number of execution of the first draw, a status of change of the areas to the winning area, and a status of giving of the first reward.

7. The system of claim 1, wherein the operations further comprise increasing the remaining draw count in association with consumption of a predetermined value by the player.

8. The system of claim 1, wherein the operations further comprise, in response to the area corresponding to the winning identification information being changed to the winning area, giving a second reward to the player.

9. The system of claim 8,
wherein the pieces of identification information each have a first parameter, and
wherein the giving the second reward comprises giving the second reward based on a value of the first parameter of the winning identification information.

10. The system of claim 8,
wherein the areas each have a second parameter, and
wherein the giving the second reward comprises giving the second reward based on a value of the second parameter of the area corresponding to the winning identification information.

11. The system of claim 1,
wherein the predetermined screen displays a plurality of predetermined objects corresponding to pieces of yet-to-win identification information among the pieces of identification information such that the corresponding pieces of yet-to-win identification information cannot be recognized, and
wherein the performing the first draw comprises, in response to one of the predetermined objects being specified, performing the first draw.

12. The system of claim 11,
wherein the predetermined objects each have a third parameter, and
wherein the second draw has a winning probability based on a value of the third parameter of the specified predetermined object.

13. The system of claim 11,
wherein the operations further comprise, in response to the area corresponding to the winning identification information being changed to the winning area, giving a second reward to the player,
wherein the predetermined objects each have a third parameter, and
wherein the giving the second reward comprises giving the second reward based on a value of the third parameter of the specified predetermined object.

14. The system of claim 1,
wherein the operations further comprise, in response to a first condition being satisfied, ending a play of the game that uses the game field, and
wherein the first condition is that the remaining draw count becomes zero or that a predetermined time elapses.

15. The system of claim 14,
wherein the game field has a plurality of levels, and
wherein the operations further comprise, in response to a second condition being satisfied after the play of the game is ended, changing a level of the game field for a next play of the game by the player.

16. The system of claim 1, wherein the first reward is used in another game different from the game.

17. A method for providing a game, the method being performed by one or more computers, the method comprising:
presenting, to a player, a predetermined screen that is used to play the game and displays a game field in which a plurality of areas each corresponding to one of a plurality of pieces of different identification information are arranged;
performing a first draw to determine winning identification information from among the pieces of identification information and decreasing a remaining draw count associated with the player;
in response to the winning identification information being determined through the first draw, changing an area corresponding to the winning identification information among the areas to a winning area;
in response to the winning identification information being determined through the first draw, performing a second draw to determine whether to increase the remaining draw count and, if a result of the second draw is a win, increasing the remaining draw count; and
in response to arrangement of a plurality of winning areas among the areas forming a predetermined pattern, giving a first reward to the player.

18. A non-transitory computer-readable storage medium storing a program for providing a game, the program causing one or more computers to perform operations comprising:
presenting, to a player, a predetermined screen that is used to play the game and displays a game field in which a plurality of areas each corresponding to one of a plurality of pieces of different identification information are arranged;
performing a first draw to determine winning identification information from among the pieces of identification information and decreasing a remaining draw count associated with the player;
in response to the winning identification information being determined through the first draw, changing an area corresponding to the winning identification information among the areas to a winning area;
in response to the winning identification information being determined through the first draw, performing a second draw to determine whether to increase the remaining draw count and, if a result of the second draw is a win, increasing the remaining draw count; and
in response to arrangement of a plurality of winning areas among the areas forming a predetermined pattern, giving a first reward to the player.
